(19) United States
(12) Patent Application Publication
(10) Pub. No.: US 2006/0016317 A1
(43) Pub. Date: Jan. 26, 2006

(54) String tuning device

(76) Inventor: Trevor Anthony Wilkinson, Lancashire (GB)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 11/184,152

(22) Filed: Jul. 19, 2005

(30) Foreign Application Priority Data
Jul. 21, 2004 (GB) 0416300.2

(51) Int. Cl. G10D 3/14

(52) U.S. Cl. 84/304

(57) ABSTRACT

A tuning post for a guitar having a first and second restraining means for receiving and retaining a guitar string. The first and second string restraining means are in a spaced arrangement and allow the tuning post to be rotated to tune the string.

### CROSS-REFERENCE TO RELATED APPLICATIONS

This application claims priority from GB Patent Application 0416300.2, filed Jul. 21, 2004.

The present invention relates to a device for fixing strings to a musical instrument, for example a guitar. More particularly, the invention concerns a tuning post arrangement mounted to the head stock of a guitar.

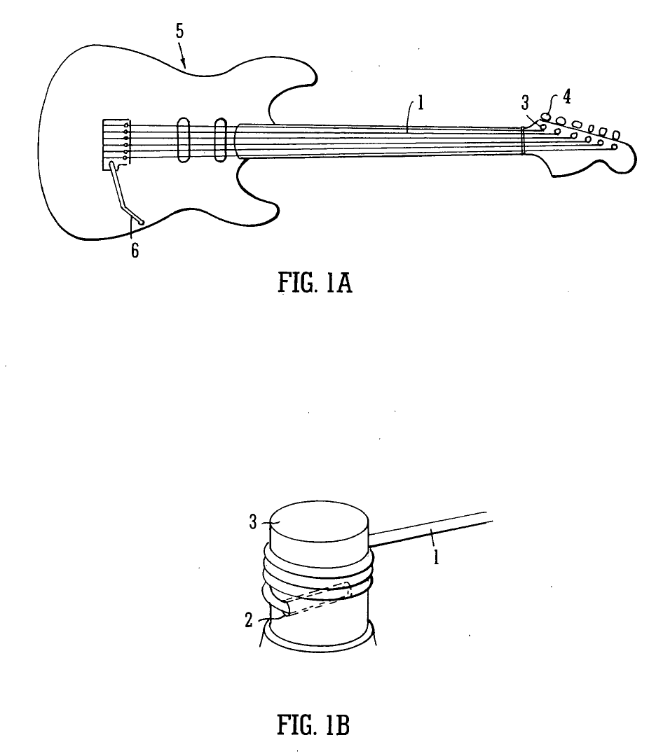

The design of tuning post for a guitar is well known, one example is illustrated in FIGS. 1A and 1B in which the string 1 is inserted through the hole 2 and then looped several times around a post 3. It is then tightened by turning the tuning head 4 to tighten the string. The tuning head 4 is connected to the tuning post 3 by a gear arrangement so that as the tuning head 4 is tuned the tuning post 3 is caused to be rotated which tightens or loosens the string.

A common problem affecting guitars is that of de-tuning, whereby the tension of the string changes over time which alters the pitch. Furthermore, the string can be subjected to repeated slackening and tensioning which results in the string becoming de-tuned. This is a particular problem for electric guitars 5 when a tremolo arm 6 is provided (see FIG. 1A).

This general problem has been identified in prior art documents, for example U.S. Pat. No. 4,453,443. This document is concerned with the string termination unit mounted in the body of the guitar. The present invention is directed to solving the problem for a tuning post mounted to the head stock and, as such, needs to be capable of tuning the string of a guitar.

Past designs of tuner post attempting to alleviate this problem have employed a mechanical means of attaching the strings thereby allowing virtually no wraps around the post. This greatly enhances tuning stability but the resultant increase in cost over a standard tuner (approximately 3 to 4 times) means that these devices can only be fitted to the more expensive products in the market.

These are known collectively in the relevant industries as “Locking tuners” in so much as they utilise a mechanical element that exerts a clamping force to the diameter of the string thereby holding it in place by the use of a mechanical clamping device.

This not only adds cost to the tuners due to the sometimes considerable extra parts needed but also adds unwanted weight to the tuners which, due to their location (usually on the instruments head stock), detrimentally effects the balance of the instrument.

The present invention and its preferred embodiments seek to overcome or at least mitigate the problems of the prior art.

A first aspect of the invention provides a tuning post for a guitar having a first and second restraining means for receiving and retaining a guitar string, said first and second string restraining means are in a spaced arrangement and allow the tuning post to be rotated to tune the string.

Preferably, the string is looped around the post between the first and second string restraining means.

In one class of embodiments the first restraining means is a lateral hole in the tuning post through which the string passes to be looped around the post thereby restricting movement of the string.

Optionally, the second restraining means comprises a second lateral hole in the tuning post through which the looped strong from the first restraining means passes to be retained therein. The first and second lateral holes may be oriented in an offset arrangement, or more preferably, in a substantially perpendicular arrangement.

In another class of embodiments, the first restraining means is a slot formed in the upper end of the post through the tuning post wherein the string passes through the slot to be looped around the post thereby restricting movement of the string.

The second restraining means may instead comprise a slot formed in the upper end of the post through the tuning post through which the looped string from the first restraining means passes to be retained therein. The slot forming the second restraining means may be offset the first restraining means.

There may comprise a bore passing through the longitudinal axis of the tuning post between the slot of the second restraining means and the lower end of the post, which bore receives the end of the string.

Optionally, side walls of the or each slot converge thereby providing an interference fit to receive and retain the string.

A second aspect of the invention provides a guitar having a head stock comprising a plurality of tuning heads connected to corresponding tuning post as described above capable of being rotated by rotating the corresponding tuning head.

A third aspect of the invention provides a tuning post for a guitar having a lateral hole or slot having distal and proximal ends through which the string passes to be engaged beyond the proximal end of the hole or slot, which tuning post is rotated to tune the string causing the string to abut the edge of the distal end of the hole for slot.

A fourth aspect of the invention provides a string restraining device for a guitar having first and second string restraining means in a spaced arrangement for receiving and restraining the string, which string is looped around the device between the first and second string restraining means.

The present invention allows the string to be attached in a manner which eliminates the need for multiple wraps of string around the post to achieve tuning the string to its' desired pitch and also to eliminate any slipping of the string (and its' resulting loss of tuning stability).

Exemplary embodiments will now be described, by way of example only, with reference to the accompanying drawings in which:

FIG. 1A and 1B illustrate a known guitar and a conventional turning post respectively;

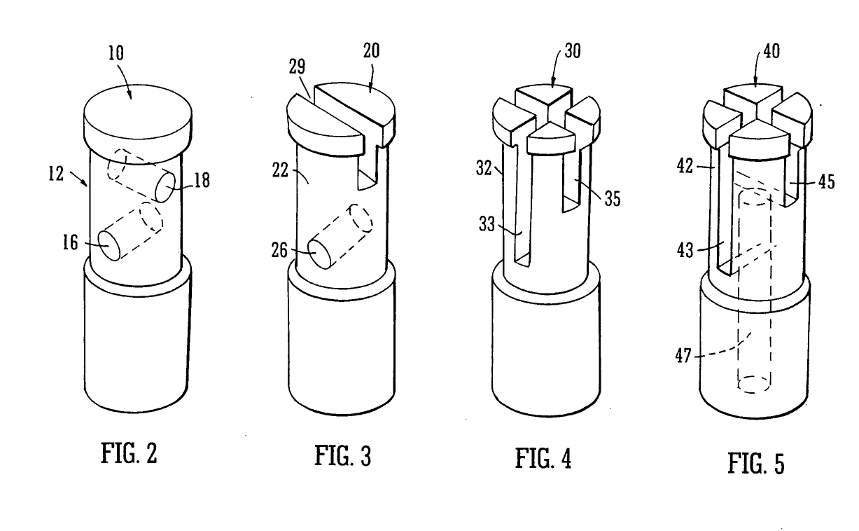

FIG. 2 illustrates a tuning post according to a first embodiment of the invention;

FIG. 3 illustrates the tuning post according to a second embodiment of the invention;

FIG. 4 illustrates a tuning post according to a third embodiment of the invention;

FIG. 5 illustrates a tuning post according to a fourth embodiment of the invention;

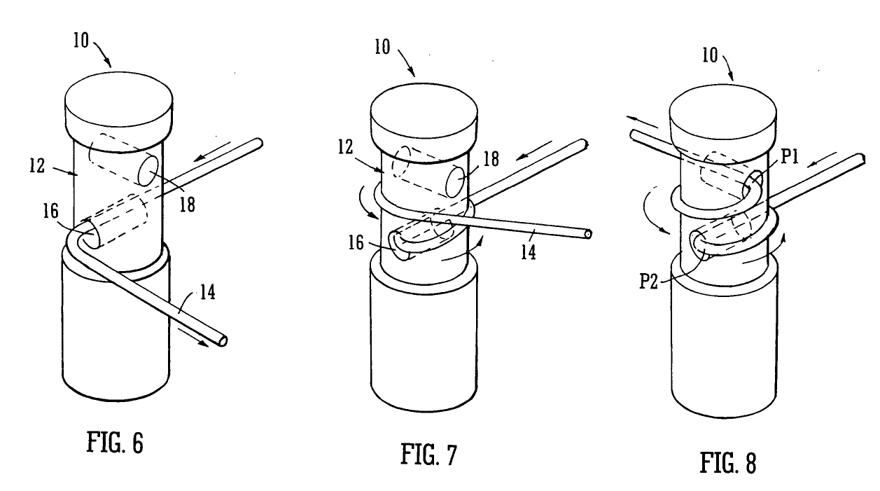

FIGS. 6, 7 and 8 illustrate the process of connecting the string to the post of the first embodiment shown in FIG. 2;

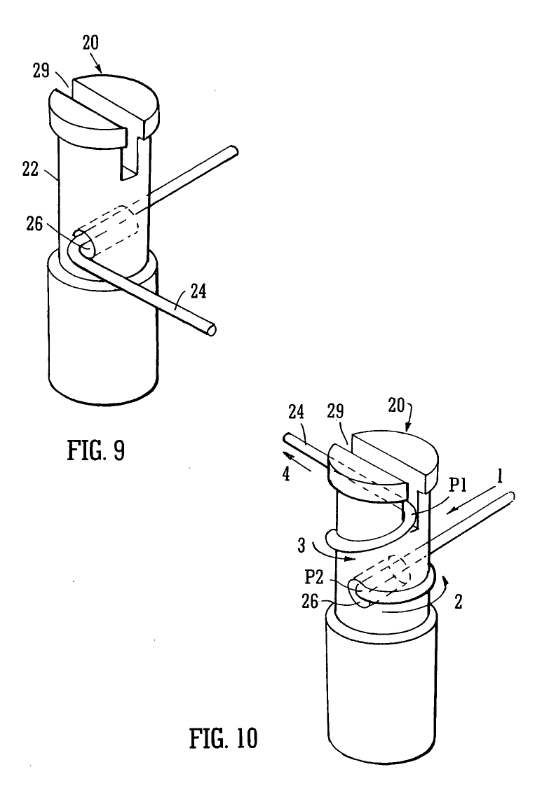

FIGS. 9 and 10 illustrate the process of connecting the string to the post of the second embodiment shown in FIG. 3;

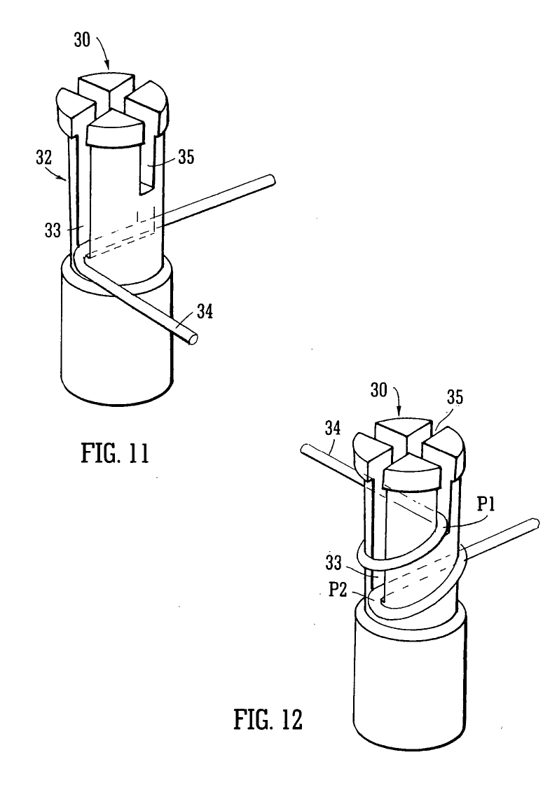

FIGS. 11 and 12 illustrate the process of connecting the string to the post of the third embodiment shown in FIG. 4; and

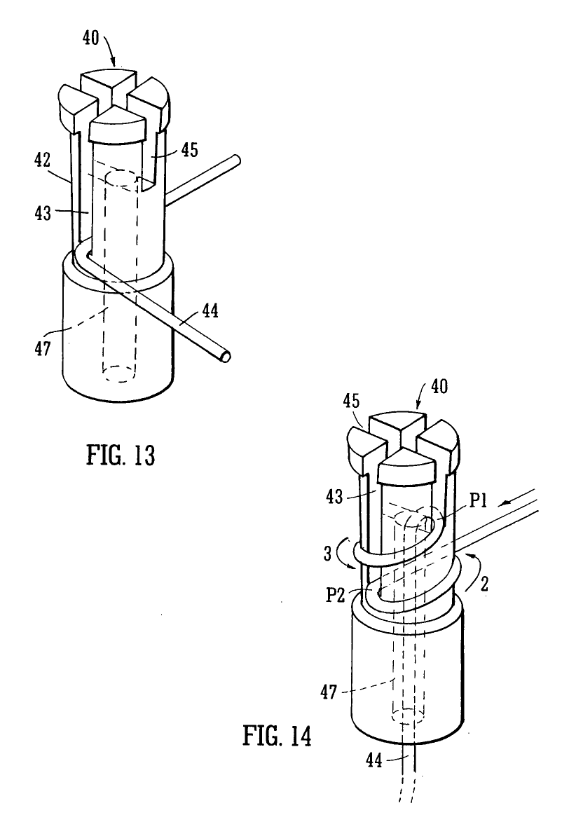

FIGS. 13 and 14 illustrate the process of connecting the string to the post of the fourth embodiment shown in FIG. 5.

Turning to the drawings and in particular FIGS. 1A and 1B which shows a conventional tuning post 3. One end of the string 1 is inserted in the hole 2. The post 3 is then rotated several times to take up the slack from the string 1 and is tightened to the desired tension to tune it. As the string 1 is tightened and loosened repeatedly, for example by repeated use of the tremolo arm 6 (shown in FIG. 1A) the part of the string 1 looped around the tuning post 3 will tend to move slightly which results in the string 1 being de-tuned. As mentioned above, this is undesirable.

The present invention addresses this problem by providing alternative arrangements of tuning post; examples are shown in FIGS. 2, 3, 4 and 5.

Turning to the post arrangement of the first embodiment illustrated in FIG. 2, there comprises a tuning post 10 which is preferably cylindrical in shape and is provided with a recess 12, to receive the string 14 (FIG. 6). There further comprises a first hole 16 and a second hole 18. Preferably the second hole 18 is not aligned in the same plane as the first hole, and, more preferably, it is oriented in a substantially perpendicular arrangement to the first hole 16.

The tuning post is connected to the tuning head by a suitable known gearing arrangement, so that it can be rotated by a user.

The second embodiment illustrated in FIG. 3 is similar in overall construction to the first embodiment in that it comprises a tuning post 20 connected to the tuning head (not shown) and is provided with a recess 22 and a first hole 26. In this embodiment, the second hole is replaced by a slot 29 which is adapted to receive the end portion of the string 24.

In the third embodiment shown in FIG. 4, the tuning post 30 comprises a recess 32, a first slot 33 and a second slot 35 provided in the upper end of the post 30. The slots are oriented in a substantially perpendicular arrangement. Of course, in other embodiments the orientation may be altered to particular user requirements. The first slot 33 is deeper than the second slot 35, and both slots 33 and 35 receive the string (not shown).

The fourth embodiment of the tuning post 40 shown in FIG. 5 is similar to the third embodiment and like references have been used with the prefix “4”0. Therefore, only the differences will be described in any great detail. In this fourth embodiment there further comprises a bore 47 following the longitudinal axis of the post 40. The bore 47 is shaped to receive surplus string after passing through the second slot. The string will then exit from the base of the tuner to be trimmed off after tuning to pitch. Beneficially, this eliminates any sharp ends of cut strings from the head stock.

It is envisaged that the bore 47 could also be applied to the second embodiment shown in FIG. 3, without departing from the scope of the invention.

Turning to the process of stringing the tuning post 10, for the first embodiment, reference is made to FIGS. 6 to 8.

The first step is to pull the string 14 through the first hole 12, pull it tight and bend it, as shown in FIG. 6. Thereafter, the string is looped around the post at least once, shown in FIG. 7. Finally, it passes through the second hole 16 where it terminates, shown in FIG. 8.

The end of the string 14 is held in place because it is kinked at the point designated P1 in FIG. 8 and will tend to remain in situ. The string 14 is tuned by turning the tuning head (not shown). Thus, the tuning post 10 will retain the string at the desired tension because it is retained by the post 10 at two points P1 and P2 and due to the reduction in loops of the string.

The process of stringing the second embodiment of post 20 is similar to the first embodiment and reference is made to FIGS. 9 and 10.

The first step is to pull the string 24 through the first hole 26, pull it tight and bend it, as shown in FIG. 5. Thereafter, the string 24 is looped around the post 20 at least once. Finally, it passes through the slot hole 29 where it terminates, as shown in FIG. 10.

Like the first embodiment, the string 24 is held in place because it is kinked at the point designated P1 in FIG. 5 and will tend to remain in situ. The string 14 retains the desired tension because it is retained at two points P1 and P2 and due to the reduction in loops of string.

The process of stringing the third embodiment of post 20 is similar to the first embodiment and reference is made to FIGS. 11 and 12.

The first step is to insert the string 34 into the first slot 33, and lower it to the base of the slot. The string 34 is then pulled tight and bent, as shown in FIG. 11. Thereafter, the string 34 is looped around the post 30 at least once. Finally, it passes through the second slot 35 where it terminates, as shown in FIG. 12.

The string 34 is held in place because it is kinked at the point designated P1 in FIG. 12 and will tend to remain in situ. The string 34 is tuned to the desired tension and maintains retention because it is retained at two points P1 and P2 and due to the reduction in loops of string.

The process of stringing the fourth embodiment of post 20 is similar to the third embodiment and reference is made to FIGS. 13 and 14.

The first step is to insert the string 44 through the first slot 43, and lower it to the base of the slot 43. The string 44 is then pulled tight and bent, as shown in FIG. 13. Thereafter, the string 44 is looped around the post 40 at least once and passes through the second slot 45 where it terminates. Finally, the surplus string 44 is directed down the centre of the post through the bore 47 after passing through the slot 45 and exits out of the base of the tuner to be trimmed off after tuning to pitch, shown in FIG. 14.

The string 44 is held in place because it passes through slot 45 and the bore 47 in FIG. 14 and will tend to remain in situ. The string 44 is tuned to the desired tension and maintains retention because it is retained at two points P1 and P2 and due to the reduction in loops of string.

Various modifications are envisaged to the application, without departing from the scope of the invention, for example the slots could be shaped so that their side wall converge, thereby providing an interference type fit. Furthermore, it is anticipated that the tuning post arrangement can be applied on a retrofit basis to existing guitars or supplied with new guitars.

1. A tuning post for a guitar having a first and second restraining means for receiving and retaining a guitar string, said first and second string restraining means being in a spaced arrangement which permits the tuning post to be rotated to tune the string.

2. A tuning post as claimed in claim 1, wherein the string can be looped around the post between the first and second string restraining means.

3. A tuning post as claimed in claim 1, wherein the first restraining means is a lateral hole in the tuning post through which the string passes to be looped around the post thereby restricting movement of the string.

4. A tuning post as claimed in claim 3, wherein the second restraining means comprises a second lateral hole in the tuning post through which the looped string from the first restraining means can pass to be retained therein.

5. A tuning post as claimed in claim 4, wherein the first and second lateral holes are oriented in an offset arrangement.

6. A tuning post as claimed in claim 5, wherein the first and second holes are in a substantially perpendicular arrangement.

7. A tuning post as claimed in claim 1, wherein the first restraining means is a slot formed in the upper end of the post through the tuning post wherein the string can pass through the slot to be looped around the post thereby restricting movement of the string.

8. A tuning post as claimed in claim 7, wherein the second restraining means comprises a slot formed in the upper end of the post through the tuning post through which the looped string from the first restraining means can pass to be retained therein.

9. A tuning post as claimed in claim 8, wherein the slot forming the second restraining means is offset relative to the first restraining means.

10. A tuning post as claimed in claim 8, further comprising a bore passing through the longitudinal axis of the tuning post between the slot of the second restraining means and the lower end of the post, which bore is adapted to receive the end of a guitar string.

11. A tuning post as claimed in claim 7, wherein side walls of the or each slot converge thereby providing an interference fit to receive and retain the string.

12. A guitar having a head stock comprising a plurality of tuning heads each connected to a corresponding tuning post as claimed in claim 1 and capable of being rotated by rotating the corresponding tuning head.

13. A tuning post for a guitar, the post having a lateral hole or slot having distal and proximal ends through which a guitar string can pass to be engaged beyond the proximal end of the hole or slot, which tuning post can be rotated to tune the string in a manner causing the string to abut the edge of the distal end of the hole or slot.

14. A string restraining device for a guitar, said device having first and second string restraining means in a spaced arrangement for receiving and restraining the string, which string is looped around the device between the first and second string restraining means.
